(19) United States
(12) Patent Application Publication
(10) Pub. No.: US 2025/0342056 A1
(43) Pub. Date: Nov. 6, 2025

(54) Correlating Local Resolvers to Clients

(71) Applicant: International Business Machines Corporation, Armonk, NY (US)

(72) Inventors: Mauro Marzorati, Lutz, FL (US); Cheng-Ta Lee, Cumming, GA (US); Christopher A. Kulakowski, Austin, TX (US); Priti P. Patil, Pune (IN)

(21) Appl. No.: 18/651,801

(22) Filed: May 1, 2024

(51) Int. Cl. G06F 9/50

(52) U.S. Cl. CPC G06F 9/5027

(57) ABSTRACT

A computer implemented method correlates a local resolver to a client. The local resolver requesting an address to a resource from an authoritative domain name server is identified. An access pattern defining servers for accessing the resource over time slices is determined. The servers are assigned to the time slices and are configured to record requests to access the resource. Sending responses from the authoritative domain name server to the local resolver is initiated using the access pattern. Each response in the responses has the address to a server assigned to a current time slice during which a request for a new address is received from the local resolver. Whether the requests to access the resource from the client match the access pattern is determined. The local resolver is associated with the client in response to the requests matching the access pattern.

### BACKGROUND

The disclosure relates generally to an improved computer system and more specifically to correlating local resolvers to clients using the local resolvers.

The domain name system (DNS) translates human readable domain names into Internet Protocol (IP) addresses. These IP addresses are the addresses used by computing devices to identify each other on a network. When a domain name is entered into a browser on a computer, the computer queries DNS servers to find the IP address corresponding to the domain name. The IP address is used to request access to a resource such as a website. The domain name system operates as a hierarchical decentralized system. This system has different levels of DNS servers. These DNS servers include root servers, top-level domain servers (TLD), and authoritative domain name servers for specific domains. The servers in the domain name system also include recursive DNS servers. These servers fully resolve requested domain names into IP addresses for clients. These servers are recursive servers and are also referred to as local resolvers.

Different providers of computing services and networks typically provide local resolvers to their local computing devices. These local resolvers are separate from and form a shared resource for the local computing devices that access cloud-based services and other services via a network.

A malicious application can exploit this domain name system resolution to carry out attacks or gain unauthorized access to resources. For example, DNS spoofing and DNS tunnelling can be performed. Also, attackers can exploit vulnerabilities in DNS servers or protocols. For example, denial of service attacks can be made. Also, malicious applications can gather information about the structure of the network and identify potential vulnerabilities. This information can be gathered by querying DNS records to obtain information about servers, domain ownership, network configurations, and other information about networks.

### SUMMARY

According to one illustrative embodiment, a computer implemented method correlates a local resolver to a client. A processor set identifies the local resolver requesting an address to access a resource from an authoritative domain name server. The processor set determines an access pattern defining servers for accessing the resource over time slices. The servers are assigned to the time slices and the servers are configured to record requests to access the resource received during the time slices. The processor set initiates sending responses from the authoritative domain name server to the local resolver using the access pattern in response to the local resolver requesting new addresses to the resource. Each response in the responses has the address to a server in the servers assigned to a current time slice in the time slices during which a request for a new address is received from the local resolver to access the resource. The processor set determines whether the requests to access the resource from the client recorded by the servers match the access pattern. The processor set associates the local resolver with the client in response to the requests from the client matching the access pattern.

According to other illustrative embodiments, a computer system and a computer program product for correlating a local resolver to a client are provided.

### BRIEF DESCRIPTION OF THE DRAWINGS

FIG. 1 is a block diagram of a computing environment in accordance with an illustrative embodiment;

FIG. 2 is a block diagram of domain name environment in accordance with an illustrative embodiment;

FIG. 3 is a block diagram of an access pattern in accordance with an illustrative embodiment;

FIG. 4 is a block diagram of an entry in the log in accordance with an illustrative embodiment;

FIG. 5 is a block diagram of access methods using access patterns in accordance with an illustrative embodiment;

FIG. 6 is a data flow diagram for correlating a client with a local resolver in accordance with an illustrative embodiment;

FIG. 7 is a data flow diagram illustrating pattern generation matching in accordance with an illustrative embodiment;

FIG. 8 is a heatmap correlating a local resolver to clients in accordance with an illustrative embodiment;

FIG. 9 is a barcode for correlating a local resolver to clients in accordance with an illustrative embodiment;

FIG. 10 is a flowchart of a process for correlating a local resolver to a client in accordance with an illustrative embodiment;

FIG. 11 is a flowchart of a process for performing actions in accordance with an illustrative embodiment;

FIG. 12 is a flowchart of a process for identifying the local resolver in accordance with an illustrative embodiment;

FIG. 13 is a flowchart of a process for determining an access pattern in accordance with an illustrative embodiment;

FIG. 14 is a flowchart of a process for determining an access pattern in accordance with an illustrative embodiment; and

FIG. 15 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

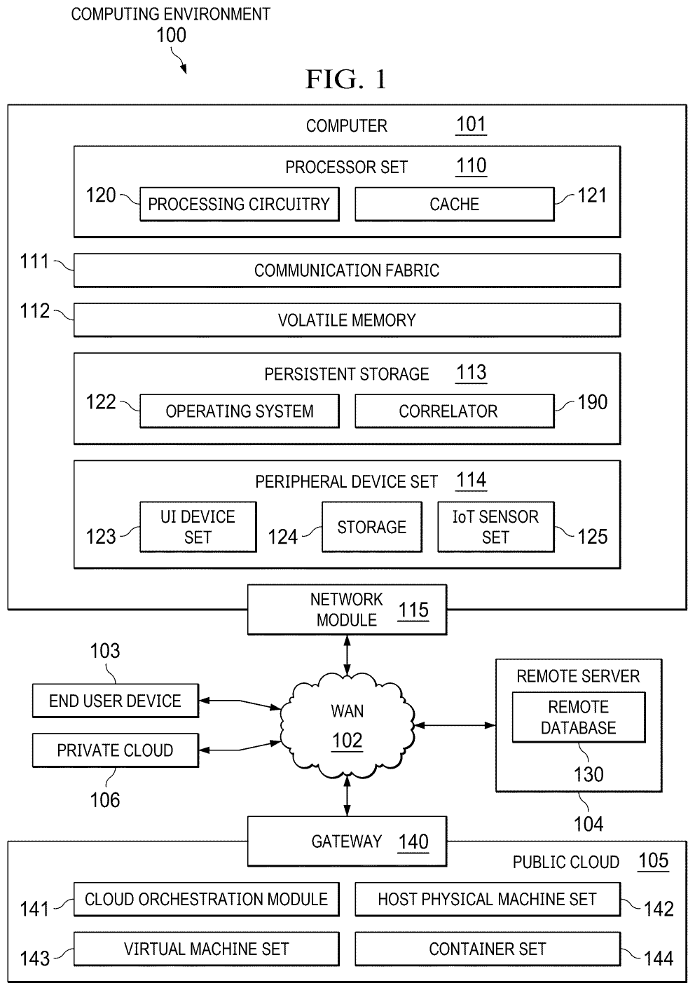

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as correlator 190. In addition to correlator 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and correlator 190, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in correlator 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in correlator 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. Currently, identifying local resolvers that contribute to malicious traffic cannot be performed using current techniques because the client requesting access to the resource is not directly observable. The client makes DNS requests to a local resolver. This local resolver then makes a request to an authoritative domain name server to obtain the IP address to the resource.

The client and the resolver are seldom the same component. A local resolver typically services thousands of clients at any given time. Thus, identifying the client using a resolver for malicious purposes can be extremely difficult and impossible to perform.

Thus, the illustrative embodiments provide a method, apparatus, and system to correlate the client accessing a resource to the local resolver. This determination can be made using selected domain name system responses sent from an authoritative domain name server, logging access requests to servers identified in the responses, and analyzing logs of these access requests.

In one illustrative example, a computer implemented method correlates a local resolver to a client. The local resolver requesting an address to access a resource from an authoritative domain name server is identified. An access pattern defining servers for accessing the resource over time slices are determined. The servers are assigned to the time slices. The servers are configured to record requests to access the resource received during the time slices. Sending responses from the authoritative domain name server to the local resolver using the access pattern is initiated in response to the local resolver requesting new addresses to the resource. Each response in the responses has the address to a server in the servers assigned to a current time slice in the time slices during which a request for a new address is received from the local resolver to access the resource. Whether the requests to access the resource from the client recorded by the servers match the access pattern is determined. The local resolver is associated with the client in response to the requests from the client matching the access pattern.

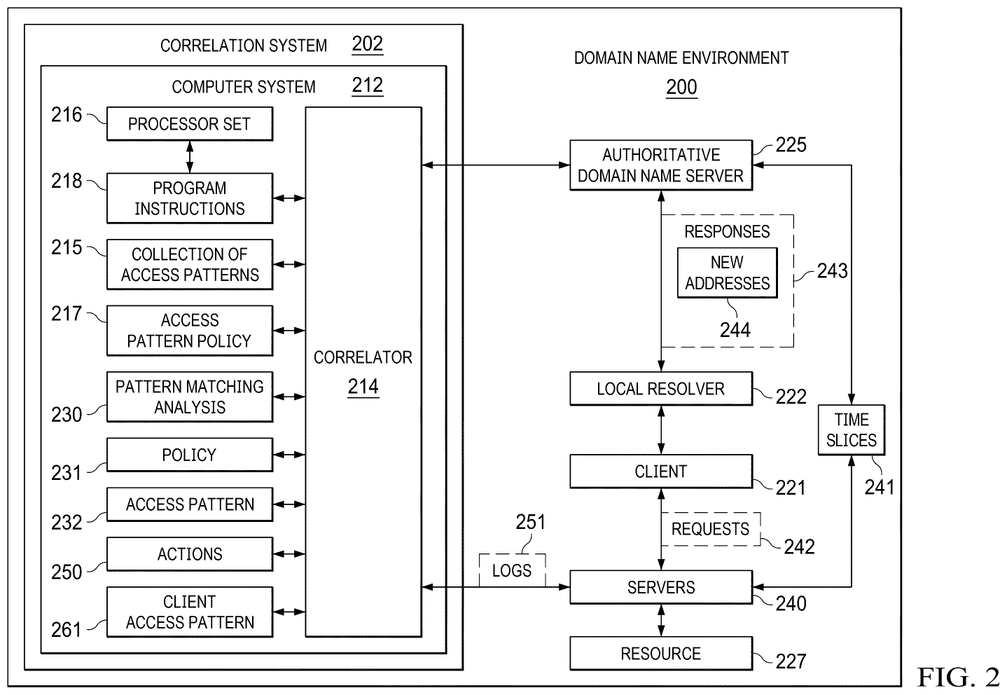

With reference now to FIG. 2, a block diagram of a domain name environment is depicted in accordance with an illustrative embodiment. In this illustrative example, domain name environment 200 includes components that can be implemented in hardware such as the hardware shown in computing environment 100 in FIG. 1. In this example, correlation system 202 can operate to correlate local resolvers to clients requesting access to resources.

In this illustrative example, correlation system 202 comprises a number of different components. As depicted, correlation system 202 comprises computer system 212 and correlator 214. Correlator 214 is located in computer system 212.

Correlator 214 can be implemented using correlator 190 in FIG. 1. Correlator 214 can be implemented in software, hardware, firmware or a combination thereof. When software is used, the operations performed by correlator 214 can be implemented in program instructions configured to run on hardware, such as a processor unit. When firmware is used, the operations performed by correlator 214 can be implemented in program instructions and data and stored in persistent memory to run on a processor unit. When hardware is employed, the hardware can include circuits that operate to perform the operations in correlator 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units and can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can be include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, correlator 214 can perform pattern matching analysis 230 to correlate local resolver 222 to client 221. In these examples, client 221 can be a hardware device, software, or combination of the two. Local resolver 222 is a domain name system server that resolves domain names to addresses by querying authoritative domain name server (aDNS) 225. In this example, addresses can take a number of different forms. For example, the addresses can be selected from at least one of an Internet Protocol (IP) address, a media access control (MAC) address, or other address that can be used in a network to access resources.

In this illustrative example, client 221 can request an address to resource 227 using local resolver 222. Resource 227 can take a number of different forms. For example, resource 227 can be selected from a group comprising an application, a website, a web application, a database, a service, and other suitable types of resources. For example, client 221 can send a domain name to local resolver 222. Local resolver 222 can follow currently used domain name system processes to locate authoritative domain name server 225 to provide the address to resource 227. The process can involve local resolver 222 sending requests to root domain name servers and top level domain (TLD) name servers to identify and contact authoritative domain name server 225 to obtain the address to resource 227.

In this illustrative example, correlator 214 can identify local resolver 222 for pattern matching analysis 230 using policy 231. In this example, local resolver 222 can be identified from candidate local resolvers as candidates for pattern matching analysis 230 in response to these candidate local resolvers sending requests to authoritative domain name server 225. These candidates can be streamed from authoritative domain name server 225 as authoritative domain name server 225 receives requests from these candidate local resolvers.

In this illustrative example, correlator 214 can determine whether local resolver 222 meets policy 231 for enabling pattern matching analysis 230. In this illustrative example, policy 231 is a number of rules. Policy 231 can also include information or data used to apply the rules. This policy can be used to select local resolver 222 for pattern matching analysis 230.

The rules and policy 231 can be used to enable this analysis for specific organizational needs. For example, policy 231 can include a static domain watchlist, a dynamic domain watchlist, a presence of a redirect or multi-redirect for specific codes, a presence of an uncached DNS resolver response, a local resolver in a specific location of a network, a local resolver for a critical location network, a local resolver associated with a presence of malicious activity, a local resolver associated with the security breach in the network, or other suitable factors that can be used to generate rules for enabling pattern matching analysis 230. The rules in policy 231 can also include initiating pattern matching analysis 230 for local resolver 222 when pattern matching conditions other are present in addition to these examples.

In response to identifying local resolver 222, access pattern 232 defining servers 240 for accessing resource 227 over time slices 241 is determined. In this illustrative example, access pattern 232 can be determined in a number of different ways. For example, access pattern 232 can be determined by correlator 214 selecting access pattern 232 from collection of access patterns 215, wherein each pattern in the collection is unique from other access patterns in the collection. This collection can be a database, a table, or some other data structure containing access patterns from which access pattern 232 can be selected.

In another example, correlator 214 can determine access pattern 232 by generating access pattern 232 using access pattern policy 217 defining access pattern generation. In this manner, access pattern 232 can be dynamically generated in response to determining access pattern matching analysis 230 should be performed for local resolver 222. This policy can be used by correlator 214. In other examples, this policy can be sent to authoritative domain name server 225 to generate access pattern 232. This policy can take the form of program code or rules for pattern generation.

In this illustrative example, servers 240 are assigned to time slices 241, which are periods of time during which servers 240 are valid for accessing resource 227 with respect to performing pattern matching analysis 230. Also in this example, servers 240 are configured to record requests 242 to access resource 227 received during time slices 241.

Correlator 214 initiates sending responses 243 from authoritative domain name server 225 to local resolver 222 using access pattern 232 in response to local resolver 222 requesting new addresses 244 to resource 227. Responses 243 contains new addresses 244. In this example, each response in responses 243 has an address to a server in servers 240 assigned to a current time slice in time slices 241 during which a request for a new address is received from local resolver 222 to access resource 227. In turn, these responses are sent to client 221 for use in requesting access to resource 227.

In this illustrative example, the address used to access resource 227 can change over time. Each of these accesses can be valid for a single time slice. In other words, the address can expire at the end of each time slice in time slices 241 in these examples. In this example, servers 240 report requests 242 received from client 221. Further, servers 240 can also receive requests 242 from other clients in addition to client 221 depending on the particular implementation. This information can be recorded in logs 251. These logs are sent by servers 240 to correlator 214 for analysis.

In this illustrative example, correlator 214 analyzes logs 251 received from servers 240. This analysis performed by correlator 214 is used to determine whether requests 242 to access resource 227 from client 221 recorded by servers 240 match access pattern 232.

This analysis performed by correlator 214 can include creating client access pattern 261 from logs 251 received from servers 240. In this example, this client access pattern is for client 221 based on requests 242 and identify the logs 251 made during time slices 241. Client access pattern 261 can be compared to access pattern 232 to determine whether a match is present. If a match is present, that means client 221 received responses 243 from local resolver 222 that originated from authoritative domain name server 225 using access pattern 232.

In this example, correlator 214 associates local resolver 222 with client 221 in response to requests 242 from client 221 matching access pattern 232. In response to associating local resolver 222 with client 221, correlator 214 can perform a number of actions 250. The number of actions can be selected from at least one of assigning a reputation rating to the local resolver; ignoring an address request for the address to the resource received from the local resolver; sending a response from the authoritative domain name server to the local resolver that directs an access request for the resource to a honey pot; or other suitable actions.

In assigning a reputation to local resolver 222, an analysis can be made as to whether client 221 has performed malicious or nonmalicious actions. Further, an analysis can be made as to whether other clients in addition to client 221 have also performed malicious or nonmalicious activities. Further, the number of times client 221 has used local resolver 222 to perform malicious or nonmalicious activities can also be identified and used to determine the reputation for local resolver 222. This analysis for other clients can be made by performing pattern matching analysis 230 for local resolver 222 at other times in which other clients may use access pattern 232 to request access to resource 227.

The illustration of domain name environment and the different components in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, local resolver 222 can be one of many local resolvers present in domain name environment 200 for which correlator 214 can perform pattern matching analysis 230. With this example, an access pattern is determined for each of the local resolvers. Further, these access patterns are unique for the local resolvers. In other words, each local resolver has access patterns for accessing servers 240 that are different from other local resolvers. This difference in the access patterns can include different sequences of servers 240, different servers being included in an access pattern, or other characteristics. That difference can make the access pattern unique for a local resolver from access patterns for other local resolvers being analyzed. Further, access pattern 232 can be sent directly or indirectly to authoritative domain name server 225.

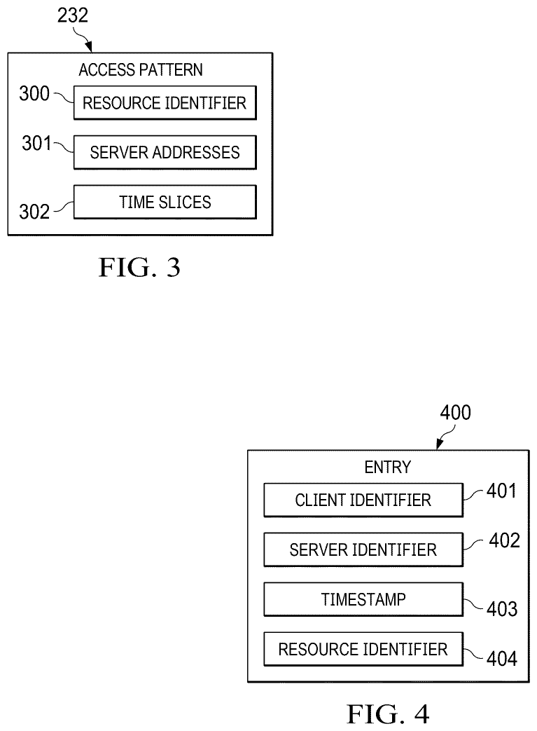

Turning next to FIG. 3, a block diagram of an access pattern is depicted in accordance with an illustrative embodiment. In the illustrative examples, the same reference numeral may be used in more than one figure. This reuse of a reference numeral in different figures represents the same element in the different figures.

In this illustrative example, access pattern 232 includes a number of different parameters. As depicted, access pattern 232 includes resource identifier 300, sequential order of server addresses 301 to servers 240, and time slices 302 assigned to servers 240.

Resource identifier 300 is an identifier that identifies resource 227 in this example, resource identifier 300 can be, for example, a media access control (MAC) address, a digital certificate, an alphanumeric string, a string, or some other identifier. Server addresses 301 are addresses for servers 240. These addresses are used to respond to local resolver 222. In access pattern 232, time slices 302 are sequential periods of time assigned to server addresses 301. These time slices are used to identify the order in which server addresses 301 for servers 240 are used in sending responses 243 for resource 227 to local resolver 222.

In these examples, multiple server addresses are present because each server address in server addresses 301 is valid for a particular time slice in time slices 302.

For example, authoritative domain name server 225 can receive a request for an address from local resolver 222 at time T. Based on policy 231, correlator 214 can monitor requests received by authoritative domain name server 225 and determine that pattern matching analysis 230 should be initiated.

With this example, time T is the time at which a response was returned by authoritative domain name server 225 prior to the pattern matching process beginning. In this example, authoritative domain name server 225 starts sending responses 243 using access pattern 232 at time T+1. In this example, time slices 302 can be periods of time based on time T. For example, time slice 1 can be for period of time t1 that is from time T+1 to time T+2, time slice can be for period of time t2 that is from time T+2 to time T+3, time slice 3 can be from a period of time t3 that is from time T+3 to time T+4, and so on for time slices 302 and access pattern 232.

In this example, local resolver 222 requests a new address each time a period of time expires. Local resolver 222 receives information identifying how long a particular address in a response is valid, which is the time period for a time slice in these examples. In these examples, a server in servers 240 can be assigned to more than one time slice and time slices 302.

These addresses are in turn sent by local resolver 222 to client 221. Client 221 uses these addresses to request access to resource 227 using servers 240 identified in the addresses sent in responses 243.

With reference now to FIG. 4, a block diagram of an entry in the log is depicted in accordance with an illustrative embodiment. In this illustrative example, entry 400 is an example of an entry that can be found in logs 251 generated by servers 240 in FIG. 2. As depicted, entry 400 comprises client identifier 401, server identifier 402, timestamp 403, and resource identifier 404.

Client identifier 401 identifies the client making the request for access. This client identifier can be, for example, an IP address, a media access control (MAC) address, or some other identifier for the clients.

In this example, server identifier 402 identifies the server receiving the request from the client. Server identifier 402 can be, for example, an IP address, a media access control (MAC) address, or some other identifier for the server.

Timestamp 403 is used to identify the time slice in which the request was received by the server. Timestamp 403 can be a time and date. Timestamp 403 can be used to correlate entry 400 with a particular time slice. This time slice can be identified from time T in which the analysis began. In another example, timestamp 403 can be a slice identifier such as t1 or t2, or some other manner in which time slices are identified.

Resource identifier 404 identifies the resource for which access was requested in the request received by the server. Resource identifier 404 can be, for example, the domain, universal resource locator (URL), or some other identifier of the resource.

This information is used by correlator 214 to generate client access pattern 261 in FIG. 2 for client 221. This pattern can then be compared to access pattern 232 in FIG. 2 to determine whether a match is present.

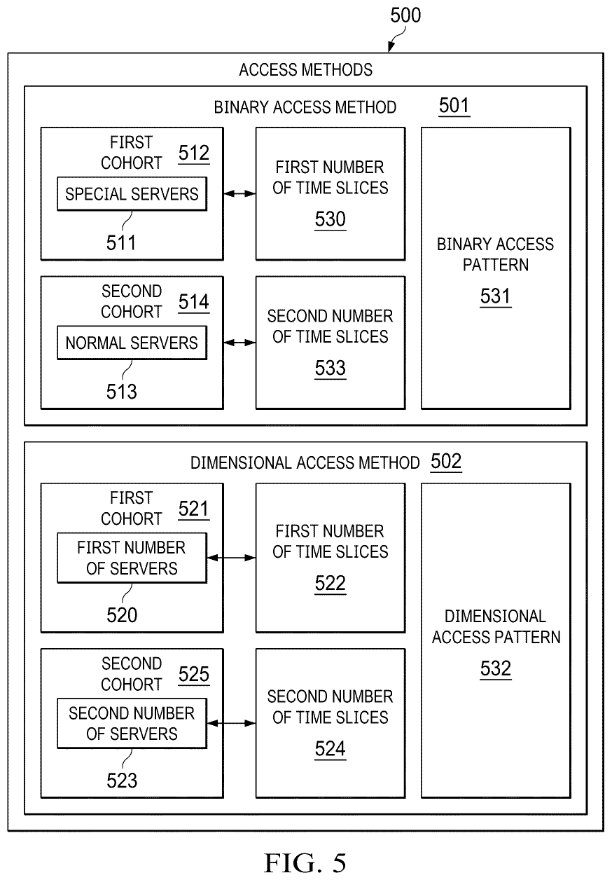

Turning next to FIG. 5, a block diagram of access methods using access patterns is depicted in accordance with an illustrative embodiment. Access methods 500 include binary access method 501 and dimensional access method 502.

In this example, binary access method 501 uses special servers 511 that are part of first cohort 512 assigned to first number of time slices 530 in which the requests to access the resource are recorded. This method also includes normal servers 513 that are part of second cohort 514 assigned second number of time slices 533 in which the requests to access the resource are not recorded. These time slices define the order in which servers are provided in responses with addresses to the resource to form binary access pattern 531.

Special servers 511 in first cohort 512 have additional capability that enables these servers to record clients accessing a resource on a given time slice. This additional capability can be provided by including program code in the form of an agent or process that enables logging information from client requests during the occurrence of time slices. Each of these time slices is a period of time such as 15 seconds, 30 seconds, 60 seconds, or some other period of time. These special servers are assigned a specific network address separate from normal servers 513.

In one example, the pattern of special servers 511 and normal servers 513 can be special, normal, normal, special, special, normal, special, and normal. The addresses for these servers are played or sent to the local resolver in this order based on the assignment of the servers to the time slices.

The authoritative domain name servers send the addresses of these servers to the local resolver starting at time T. In response, the special servers receive requests for access by clients during time slice t3, t4 and t6 but not during time slice t1, t2, t5, and t7. Any client having this access pattern can be associated with the local resolver. In this example, the reputation of the client matching the pattern transfers to the local resolver.

Dimensional access method 502 uses first number of servers 520 in first cohort 521 assigned to first number of time slices 522 and second number of servers 523 in second cohort 525 assigned to second number of time slices 524. In this example, both cohorts of servers record requests for access to the resource. These time slices define an order in which servers are provided responses with addresses of the resource to form dimensional access pattern 532.

In this illustrative example, first number of servers 520 can be blue servers while second number of servers 523 can be green servers for identification purposes. The assignment of the servers to time slices are used to identify the order of the servers and dimensional access pattern 532. For example, dimensional access pattern 532 for the servers can be blue, green, green, blue, blue, green, and blue. The addresses for the servers are played to the local resolver in this order. With this example, green servers receive requests during time slices t3, t4, and t6 but not during time slices T1, T2, and T5. The blue servers receive requests during time slices t1, t2, and t5, but not during time slices t3, t4, and t6. Clients with this access pattern are associated with the local resolver.

Further, the number of accesses by a particular client can be used to determine the strength of the association of the client to the access pattern. This strength can be used to surmount challenges when the client temporarily interrupts a journey and is not accessing the resource through either of the blue or green servers.

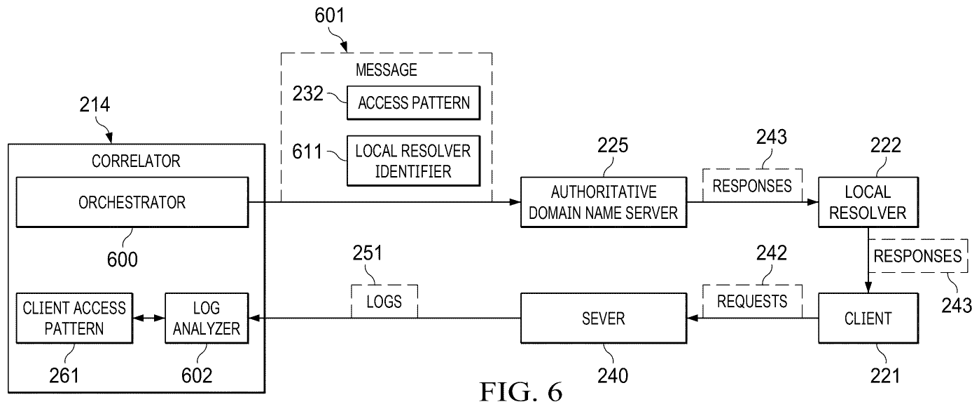

Turning next to FIG. 6, a data flow diagram for correlating a client with a local resolver is depicted in accordance with an illustrative embodiment. As depicted, correlator 214 comprises orchestrator 600 and log analyzer 602. These components can be used to perform pattern matching analysis 230.

As depicted, orchestrator 600 can enable pattern matching analysis 230 to initiate an analysis to correlate client 221 to local resolver 222. In this example, orchestrator 600 sends message 601 with access pattern 232 and local resolver identifier 611 to authoritative domain name server 225.

In this example, access pattern 232 can be stored in correlator 214 as part of collection of access patterns 215 or generated using access pattern policy 217. In another example, message 601 can include access pattern policy 217 in place of access pattern 232. This policy can be used by authoritative domain name server 225 to generate access pattern 232.

In this example, authoritative domain name server 225 can provide responses of addresses of resources to many different local resolvers. Local resolver identifier 611 is used to identify local resolver 222 as the local resolver that is to receive responses 243 for resource 227 that are based on access pattern 232.

As depicted, access pattern 232 in message 601 is used by authoritative domain name server 225 to send responses 243 to local resolver 222. Local resolver 222 provides these responses to client 221. In turn, client 221 sends requests 242 to servers 240 using these responses.

In this illustrative example, in turn, servers 240 generate logs 251 from these requests. For example, servers 240 can create logs 251 with entries containing information about requests 242 made by client 221. Servers 240 can also receive requests from other clients that can be logged. In some cases, one or more of servers 240 may be specially created to receive requests 242 based on responses 243 using access pattern 232. In other words, servers 240 can be specially created to only generate responses 243 from access pattern 232. In this manner, noise from access requests from other clients not being analyzed are not present.

As depicted, log analyzer 602 receives logs 251 from servers 240 for analysis. Log analyzer 602 can request logs 251 during the time in which authoritative domain name server 225 generates responses 243 for local resolver 222. In this example, this period of time is during time slices for which responses 243 are generated by authoritative domain name server 225. These logs can be received in response to requests made by log analyzer 602 for logs 251 created during this period of time in which servers 240 are valid for receiving requests 242 to access the resource.

In this example, log analyzer 602 generates client access pattern 261 using the information in logs 251. Log analyzer 602 also compares client access pattern 261 with access pattern 232 to determine whether a match is present. If a match is present, log analyzer 602 then associates client 221 with local resolver 222.

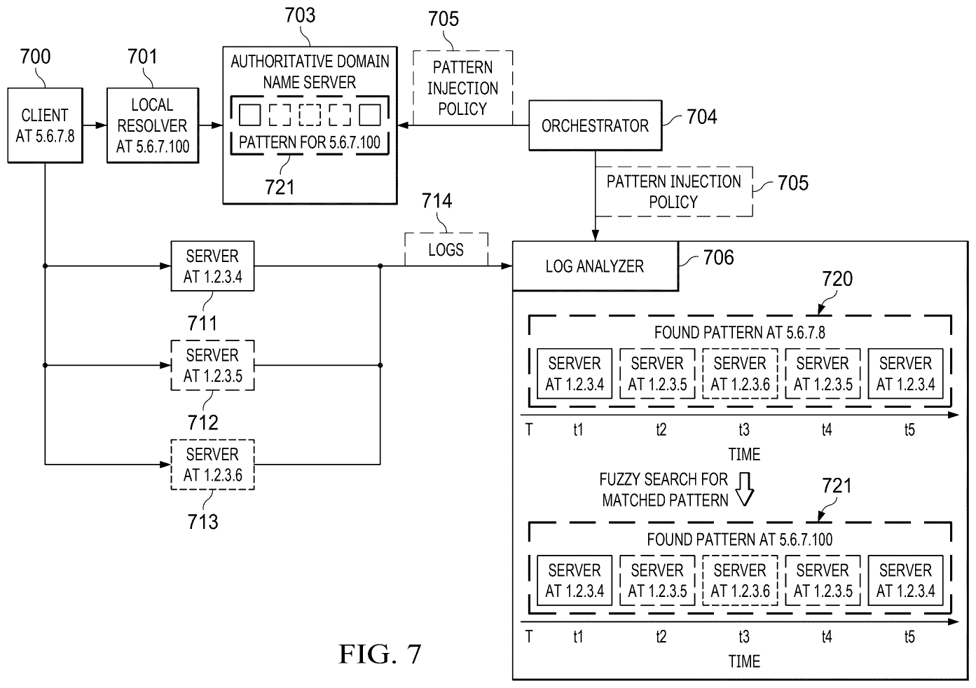

With reference now to FIG. 7, a data flow diagram illustrating pattern generation matching is depicted in accordance with an illustrative embodiment. In this illustrative example, client 700 sends a domain to local resolver 701. Local resolver 701 locates authoritative domain name server 703.

In this example, local resolver 701 has been enabled for pattern matching analysis. Orchestrator 704 sends pattern 721 to authoritative domain name server 703 for use in sending responses containing servers for accessing a resource to local resolver 701.

In this depicted example, pattern 721 is not sent directly to authoritative domain name server 703. Instead, pattern 721 is generated at domain name server 703 using pattern injection policy 705. This policy is an example of an implementation for access pattern policy 217 in FIG. 2 used by authoritative domain name server 703 to create pattern 721 at authoritative domain name server 703.

In this example, pattern injection policy 705 can take a number of different forms. For example, pattern injection policy 705 can be a pattern for use by authoritative domain name server 703. In another example, pattern injection policy 705 can be program code that can be used to generate a pattern. In one example, pattern 721 itself can encode the local resolver information. As a result, when decoded, the decoded data shows information such as the IP address or other information for local resolver 701. Additionally, pattern injection policy 705 can also include error correction encoding to support fuzzy matching.

This policy can be used to generate pattern 721 for sending responses to local resolver 701 and identify a sequence in which server 711, server 712, and server 713 and can be used to request access to a resource over different time slices. In this example, these servers for the access received from client 700 are sent in logs 714 to log analyzer 706.

In this illustrative example, log analyzer 706 generates pattern 720 from logs 714. In this example, log analyzer 706 generates pattern 721 using pattern injection policy 705. The use of pattern injection policy 705 can reduce the amount of data exchange between authoritative domain name server 703, orchestrator 704, and log analyzer 706.

Pattern 721 is compared to pattern 720. Different patterns can be present from extracting access requests from logs 714. These patterns may be different from pattern 721 used to send requests to local resolver 701 in addition to pattern 721 for analysis. In this example, the matching can be performed using a fuzzy search.

In this depicted example, a match is present between the two patterns. In response to this match, log analyzer 706 correlates local resolver 701 with client 700. In this example, pattern injection policy 705 is shown as being distributed to authoritative domain name server 703 and log analyzer 706. In other illustrative examples, pattern injection policy 705 can be located at orchestrator 704 and patterns can be sent directly to authoritative domain name server 703 and log analyzer 706 from orchestrator 704 instead of using the indirect method for sending patterns through pattern injection policy 705 in this figure.

In one illustrative example, one or more technical solutions are present that overcome a technical problem with identifying a client using a local resolver. The client does not directly request addresses from the authoritative domain name server. As a result, access requests cannot be directly tied back to a client. With the use of the pattern matching analysis in these examples, a pattern can be set for accessing servers over time and can be sent to from the authoritative domain name server a client through a local resolver. Servers in the pattern receive access requests and log this information. These logs can be examined to determine whether pattern matches present for a client. In this manner, a client can be associated with a local resolver.

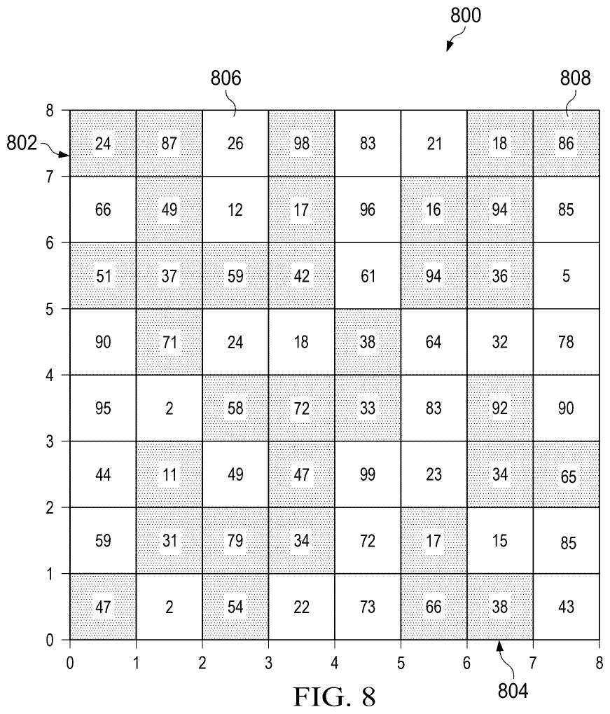

Turning next to FIG. 8, a heatmap correlating a local resolver to clients is depicted in accordance with an illustrative embodiment. In the illustrative examples, heatmap 800 can be an exemplary illustration for a collection of client access patterns such as client access pattern 261 in FIG. 2.

Heatmap 800 is a graphical representation of data. In this illustrative example, heatmap 800 can be used to visualize and analyze client access patterns such as client access pattern 261 in FIG. 2. Heatmap 800 includes rows and columns that represent different variables. In FIG. 8, y-axis 802 in heatmap 800 represents clients. In addition, x-axis 804 in heatmap 800 represents time slices. Each number in y-axis 802 represents a client and each number in x-axis 804 represents a time slice.

In x-axis 804, the number “0” can represent time T, number “1” can represent time T+1, the number “2” can represent time T+2, number “3” can represent time T+3, the number “4” can represent time T+4, the number “5” can represent time T+5, the number “6” can represent time T+6, the number “7” can represent time T+7, and the number “8” can represent time T+8.

In this illustrative example, each row in heatmap 800 represents a client access pattern for a client over a time of T+8. These client access patterns are for clients receiving responses from a local resolver.

In this illustrative example, the number in each block for heatmap 800 represents the number of accesses made by clients to a particular server. In heatmap 800, two different cohorts for servers are shown in which a first cohort is a first color, such as green, and a second cohort is a second color, such as blue.

For example, block 806 shows client “8” has made 26 requests to access a server in a first number of servers in the first cohort during a time slice from time T+2 to time T+3. In this example, block 808 shows client “8” has made 86 requests to access a server in a second number of servers in the second cohort during another time slice from time T+7 to time T+8. In other words, each block in heatmap 800 corresponds to accesses for a server in a client access pattern.

In heatmap 800, the number of accesses in each block provide additional information for matching a client access pattern to access patterns for correlating clients to local resolvers. For example, the number of accesses in each block of heatmap 800 can be used to determine the overall strength for association between client access patterns and access patterns for correlating clients to local resolvers.

In this illustrative example, a greater number in a block for heatmap 800 means a stronger association is present in those access patterns for correlating clients to local resolvers and client access patterns for the block. On the other hand, a smaller number for a block in heatmap 800 means a weaker association between those access patterns for correlating clients to local resolvers and client access patterns for the block.

In this illustrative example, client access patterns in each row of heatmap 800 can be compared to access patterns used by the authoritative domain name server in correlating clients to local resolvers. The comparison is made to determine if a client made access requests for a resource with a pattern using responses received from a local resolver in which the response has the access pattern.

The illustration of heatmap 800 in FIG. 8 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, more colors can be used in heatmap 800 to represent more cohorts of servers for different access patterns for correlating clients to local resolvers.

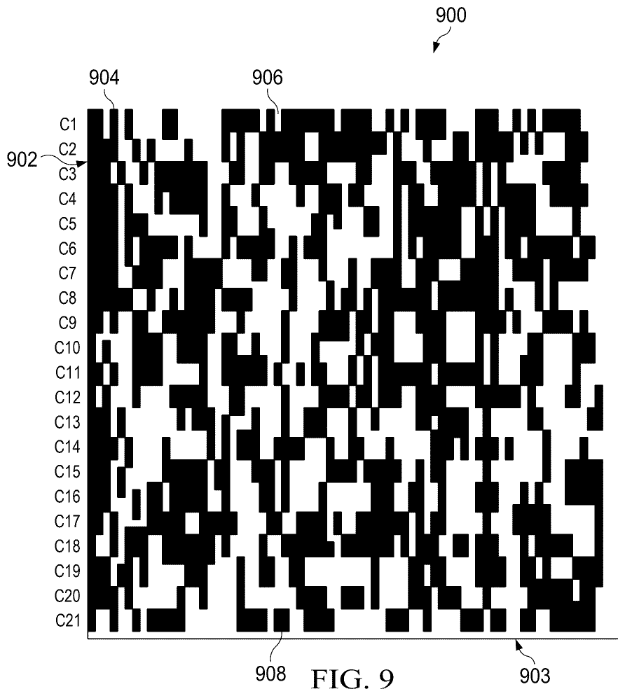

With reference now to FIG. 9, a barcode for correlating a local resolver to clients is depicted in accordance with an illustrative embodiment. In the illustrative examples, barcode 900 can be an alternative illustration for a collection of client access patterns such as client access pattern 261 in FIG. 2.

In this example, barcode 900 is a graphical representation of data and is a visualization that can be used to analyze client access patterns such as client access pattern 261 in FIG. 2. In FIG. 9, y-axis 902 in barcode 900 represents clients. In addition, x-axis 903 for barcode 900 represents time slices. As depicted, x-axis for barcode 900 includes more time slices compared to x-axis 804 in FIG. 8.

In this illustrative example, each row in barcode 900 represents a client access pattern for a client over a time period. Each of these requests for access to the resource can occur within a time slice in the time period. In this example, these client access patterns are for clients receiving responses from a local resolver.

In barcode 900, black represents a first cohort with a first number of servers. Further in barcode 900, white represents a second cohort with a second number of servers.

For example, block 904 is a is a black block that shows client “C1” made requests to access a server in a first number of servers during a time slice. In another example, block 906 is a white block that shows client “C1” made requests to access a server in a second number of servers at a different time slice.

In yet another example, block 908 is a black block showing that client “C21” made requests to access a server in the first number of servers at the same time slice in block 906, which is a white block. In other words, each block in barcode 900 corresponds to an access request sent to a server. Each row represents a pattern of access requests made by the client to the servers.

The client access pattern in each row of barcode 900 can be compared to access patterns used by the authoritative domain name server in correlating clients to local resolvers. The comparison is made to determine if any client used responses using the access pattern from local resolver to determine if any client received responses from a local resolver using the access pattern.

The illustration of barcode 900 in FIG. 9 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

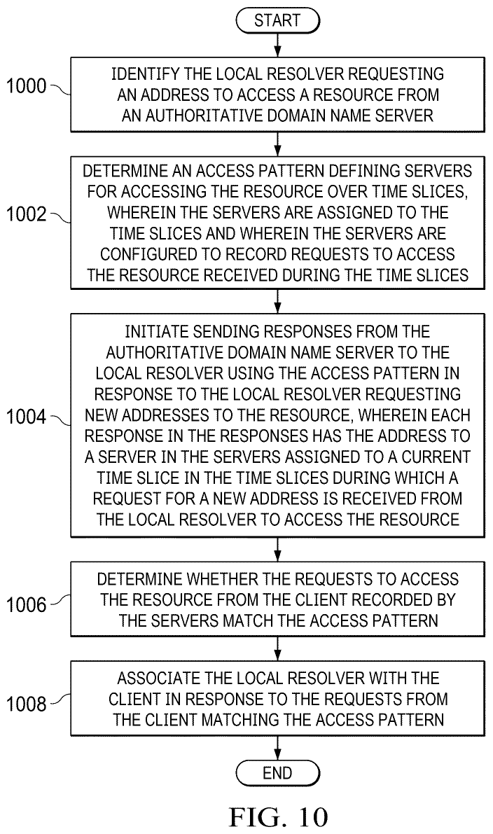

Turning next to FIG. 10, a flowchart of a process for correlating a local resolver to a client is depicted in accordance with an illustrative embodiment. The process in FIG. 10 can be implemented in hardware, software, or both. When implemented in software, the process can take the form of program instructions that are run by a processor set located in one or more hardware devices in one or more computer systems. For example, the process can be implemented in correlator 214 in computer system 212 in FIG. 2.

The process begins by identifying the local resolver requesting an address to access a resource from an authoritative domain name server (step 1000). The process determines an access pattern defining servers for accessing the resource over time slices, wherein the servers are assigned to the time slices and wherein the servers are configured to record requests to access the resource received during the time slices (step 1002).

The process initiates sending responses from the authoritative domain name server to the local resolver using the access pattern in response to the local resolver requesting new addresses to the resource, wherein each response in the responses has the address to a server in the servers assigned to a current time slice in the time slices during which a request for a new address is received from the local resolver to access the resource (step 1004). The process determines whether the requests to access the resource from the client recorded by the servers match the access pattern (step 1006).

The process associates the local resolver with the client in response to the requests from the client matching the access pattern (step 1008). The process terminates thereafter.

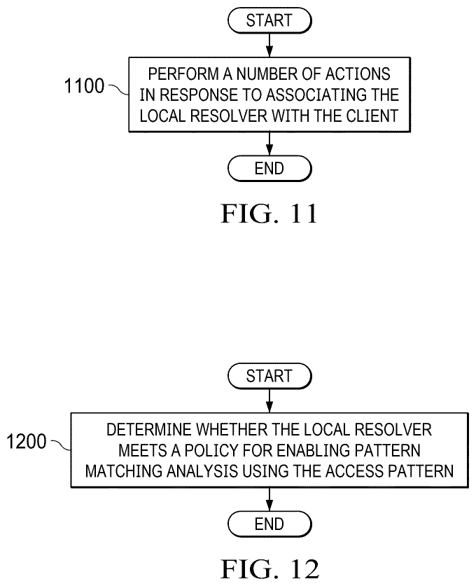

Turning next to FIG. 11, a flowchart of a process for performing actions is depicted in accordance with an illustrative embodiment. The process in this figure is an example of an additional step that can be performed with the steps in FIG. 10.

The process performs a number of actions in response to associating the local resolver with the client (step 1100). The process terminates thereafter.

Next in FIG. 12, a flowchart of a process for identifying the local resolver is depicted in accordance with an illustrative embodiment. The process in this flowchart is an example of an implementation for step 1000 in FIG. 10.

The process determines whether the local resolver meets a policy for enabling pattern matching analysis using the access pattern (step 1200). The process terminates thereafter.

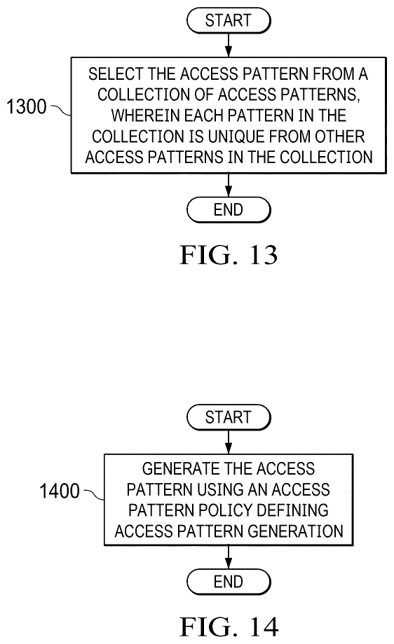

Turning to FIG. 13, a flowchart of a process for determining an access pattern is depicted in accordance with an illustrative embodiment. The flowchart in this process is an example of an implementation for step 1002 in FIG. 10.

The process selects the access pattern from a collection of access patterns, wherein each pattern in the collection is unique from other access patterns in the collection (step 1300). The process terminates thereafter.

With reference next to FIG. 14, a flowchart of a process for determining an access pattern is depicted in accordance with an illustrative embodiment. The flowchart in this process is an example of an implementation for step 1002 in FIG. 10.

The process generates, by the processor set, the access pattern using an access pattern policy defining access pattern generation (step 1400). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

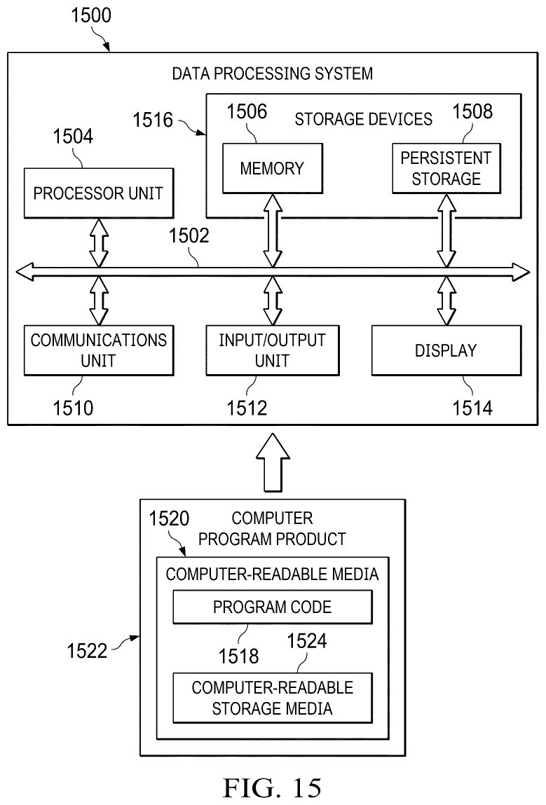

Turning now to FIG. 15, a block diagram of a data processing system is depicted in accordance with an illustrative embodiment. Data processing system 1500 can be used to implement computers and computing devices in computing environment 100 in FIG. 1. Data processing system 1500 can also be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer-readable program instructions that can be read and executed by a processor in processor unit 1504. The program instructions in the different embodiments can be embodied on different physical or computer-readable storage media, such as memory 1506 or persistent storage 1508.

Program instructions 1518 are located in a functional form on computer-readable media 1520 that is selectively removable and can be loaded onto or transferred to data processing system 1500 for execution by processor unit 1504. Program instructions 1518 and computer-readable media 1520 form computer program product 1522 in these illustrative examples. In the illustrative example, computer-readable media 1520 is computer-readable storage media 1524.

Computer-readable storage media 1524 is a physical or tangible storage device used to store program instructions 1518 rather than a medium that propagates or transmits program instructions 1518. Computer-readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1518 can be transferred to data processing system 1500 using a computer-readable signal media. The computer-readable signal media are signals and can be, for example, a propagated data signal containing program instructions 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1520” can be singular or plural. For example, program instructions 1518 can be located in computer-readable media 1520 in the form of a single storage device or system. In another example, program instructions 1518 can be located in computer-readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer-readable media 1520 in a server computer while another portion of program instructions 1518 can be located in computer-readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. In other examples, more than one processor unit can be present. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, illustrative embodiments of the present invention provide a computer implemented method, computer system, and computer program product for correlating a local resolver to a client. A processor set identifies the local resolver requesting an address to access a resource from an authoritative domain name server. The processor set determines an access pattern defining servers for accessing the resource over time slices. The servers are assigned to the time slices and the servers are configured to record requests to access the resource received during the time slices. The processor set initiates sending responses from the authoritative domain name server to the local resolver using the access pattern in response to the local resolver requesting new addresses to the resource. Each response in the responses has the address to a server in the servers assigned to a current time slice in the time slices during which a request for a new address is received from the local resolver to access the resource. The processor set determines whether the requests to access the resource from the client recorded by the servers match the access pattern. The processor set associates the local resolver with the client in response to the requests from the client matching the access pattern.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for correlating a local resolver to a client, the computer implemented method comprising:
identifying, by a processor set, the local resolver requesting an address to access a resource from an authoritative domain name server;
determining, by the processor set, an access pattern defining servers for accessing the resource over time slices, wherein the servers are assigned to the time slices and wherein the servers are configured to record requests to access the resource received during the time slices;
initiating, by the processor set, sending responses from the authoritative domain name server to the local resolver using the access pattern in response to the local resolver requesting new addresses to the resource, wherein each response in the responses has the address to a server in the servers assigned to a current time slice in the time slices during which a request for a new address is received from the local resolver to access the resource;
determining whether the requests to access the resource from the client recorded by the servers match the access pattern; and
associating the local resolver with the client in response to the requests from the client matching the access pattern.

2. The computer implemented method of claim 1, further comprising:
performing, by the processor set, a number of actions in response to associating the local resolver with the client.

3. The computer implemented method of claim 2, wherein the number of actions is selected from at least one of assigning a reputation rating to the local resolver; ignoring an address request for the address to the resource received from the local resolver; or sending a response from the authoritative domain name server to the local resolver that directs an access request for the resource to a honey pot.

4. The computer implemented method of claim 1, wherein identifying, by the processor set, the local resolver comprises:
determining, by the processor set, whether the local resolver meets a policy for enabling pattern matching analysis using access patterns.

5. The computer implemented method of claim 1, wherein determining, by the processor set, the access pattern comprises:
selecting, by the processor set, the access pattern from a collection of access patterns, wherein each pattern in the collection is unique from other access patterns in the collection.

6. The computer implemented method of claim 1, wherein determining, by the processor set, the access pattern comprises:
generating, by the processor set, the access pattern using an access pattern policy defining access pattern generation.

7. The computer implemented method of claim 1, wherein the access pattern is a binary pattern in which the servers are special servers that are part of a first cohort assigned to a first number of the time slices in which the requests to access the resource is recorded and wherein normal servers are a second cohort assigned a second number of the time slices in which the requests to access the resource are not recorded.

8. The computer implemented method of claim 1, wherein the access pattern is a dimensional pattern in which a first number of the servers in a first cohort are assigned to a first number of the time slices and a second number of the servers in a second cohort are assigned to a second number of the time slices.

9. The computer implemented method of claim 1, wherein the access pattern comprises a resource identifier, server addresses, and time slices assigned to the servers.

10. The computer implemented method of claim 1, wherein the address is selected from a group comprising an internet protocol address and a media access control address.

11. The computer implemented method of claim 1, wherein the resource is selected from a group comprising an application, a website, a web application, a database, and a service.

12. A computer system comprising:
a processor set;
a set of one or more computer-readable storage media; and
program instructions, collectively stored in the set of one or more storage media, for causing the processor set to perform the following computer operations:
identify a local resolver requesting an address to access a resource from an authoritative domain name server;
determine an access pattern defining servers for accessing the resource over time slices, wherein the servers are assigned to the time slices and wherein the servers are configured to record requests to access the resource received during the time slices;
initiate sending responses from the authoritative domain name server to the local resolver using the access pattern in response to the local resolver requesting new addresses to the resource, wherein each response in the responses has the address to a server in the servers assigned to a current time slice in the time slices during which a request for a new address is received from the local resolver to access the resource;
determine whether requests to access the resource from a client recorded by the servers match the access pattern; and
associate the local resolver with the client in response to the requests from the client matching the access pattern.

13. The computer system of claim 12,, wherein the program instructions, collectively stored in the set of one or more storage media, further causes the processor set to perform the following computer operations:
perform a number of actions in response to associating the local resolver with the client.

14. The computer system of claim 13, wherein the number of actions is selected from at least one of assigning a reputation rating to the local resolver; ignoring an address request for the address to the resource received from the local resolver; or sending a response from the authoritative domain name server to the local resolver that directs an access request for the resource to a honey pot.

15. The computer system of claim 12, wherein as part of identifying the local resolver, the program instructions, collectively stored in the set of one or more storage media, causes the processor set to perform the following computer operations:
determine whether the local resolver meets a policy for enabling pattern matching analysis using access patterns.

16. The computer system of claim 12, wherein as part of determining the access pattern, the program instructions, collectively stored in the set of one or more storage media, causes the processor set to perform the following computer operations:
select the access pattern from a collection of access patterns, wherein each pattern in the collection is unique from other access patterns in the collection.

17. The computer system of claim 12, wherein as part of determining the access pattern, the program instructions, collectively stored in the set of one or more storage media, causes the processor set to perform the following computer operations:
generate the access pattern using a policy defining access pattern generation.

18. The computer system of claim 12, wherein the access pattern is a binary pattern in which the servers are special servers that are part of a first cohort assigned to a first number of the time slices in which request to access the resource is recorded and wherein normal servers are a second cohort assigned a second number of the time slices in which the requests to access the resource are not recorded.

19. The computer system of claim 12, wherein the access pattern is a dimensional pattern in which a first number of the servers in a first cohort are assigned to a first number of time slices and a second number of the servers in a second cohort are assigned to a second number of the time slices.

20. A computer program product for correlating a local resolver to a client, the computer program product comprising:
a set of one or more computer-readable storage media;
program instructions, collectively stored in the set of one or more storage media, for causing a processor set to perform the following computer operations:
identify the local resolver requesting an address to access a resource from an authoritative domain name server;
determine an access pattern defining servers for accessing the resource over time slices, wherein the servers are assigned to the time slices and wherein the servers are configured to record requests to access the resource received during the time slices;
initiate sending responses from the authoritative domain name server to the local resolver using the access pattern in response to the local resolver requesting new addresses to the resource, wherein each response in the responses has the address to a server in the servers assigned to a current time slice in the time slices during which a request for a new address is received from the local resolver to access the resource;
determine whether the requests to access the resource from the client recorded by the servers match the access pattern; and
associate the local resolver with the client in response to the requests from the client matching the access pattern.
